(19) United States
(12) Patent Application Publication
(10) Pub. No.: US 2022/0151864 A1
(43) Pub. Date: May 19, 2022

(54) Systems, Devices, and Methods for Gamma Entrainment using Tactile Stimuli

(71) Applicants: Li-Huei Tsai, Cambridge, MA (US); Ho-Jun SUK, Cambridge, MA (US); Guojie Xu, Cambridge, MA (US); Arit Banerjee, Urbana, IL (US)

(72) Inventors: Li-Huei Tsai, Cambridge, MA (US); Ho-Jun SUK, Cambridge, MA (US); Guojie Xu, Cambridge, MA (US); Arit Banerjee, Urbana, IL (US)

(73) Assignee: Massachusetts Institute of Technology, Cambridge, MA (US)

(21) Appl. No.: 17/531,616

(22) Filed: Nov. 19, 2021

Related U.S. Application Data
(60) Provisional application No. 63/116,151, filed on Nov. 19, 2020.

(51) Int. Cl. A61H 23/00

(52) U.S. Cl. CPC A61H 23/00; A61H 2201/5048

(57) ABSTRACT

A method of treating neurodegeneration in a subject that includes administering a non-invasive tactile stimulus having a stimulus frequency of about 30 Hz to about 50 Hz to a subject to induce synchronized gamma oscillations in at least one portion of the peripheral nervous system of the subject, of the spinal cord of the subject, or both.

### CROSS-REFERENCE TO RELATED APPLICATIONS

This application claims priority to U.S. Provisional Application No. 63/116,151 filed Nov. 19, 2020, titled “SYSTEMS, DEVICES, AND METHODS FOR GAMMA ENTRAINMENT USING HAPTIC STIMULI”, the entire disclosure of which is incorporated herein by reference.

### BACKGROUND

Treatment of neurodegenerative diseases and/or conditions is a key focus in aging-related research. Some approaches describe use of visual or auditory stimulation at 40 Hz to induce gamma oscillations in patients suffering from Alzheimer's disease (AD), or dementia more generally. However, AD can cause detrimental change to the retina of the patient, which in turn can reduce effectiveness of visual stimulation. For example, the number of retinal ganglion cells is reduced, the retinal nerve fiber thickness is decreased, (ocular) vascular disorders are often observed, amyloid-β (Aβ) peptide accumulation and tau phosphorylation occur in the retina, etc. More generally, visual and auditory acuity declines with age and regardless of health. For example, macular degeneration has a prevalence rate of 2.8% for people between 40-59 years old, but rises to 13.4% for those at the age of 60 or older in the United States. As another example, rates of hearing impairment rise from 28.5% for those 50-59 years old, to 44.9% for 60-69 year olds, to 68.1% for 70-79 year olds, and 89.1% for those 80 years old or older.

### SUMMARY

In view of the foregoing, the Inventors have recognized and appreciated that visual and/or auditory stimulation can be ineffective or suboptimal in such patients. Accordingly, the inventors have further recognized and appreciated that there is hence an unmet need for effectively delivering stimulation to induce synchronized gamma oscillations in patients with significant visual and/or auditory impairment. Such stimulation may not only facilitate treatment of AD or dementia more generally, but additionally or alternatively may treat a variety of diseases or conditions (which conditions may or may not be directly related to a particular disease), and particularly diseases or conditions for which a reduction in neurodegeneration results from such stimulation.

Gamma oscillations induced by visual or auditory stimulation are also mostly confined to the brain and the effect is thus expected to be restricted to the brain, a part of the central nervous system (CNS). Generally, in vertebrates including humans, the CNS consists of the brain and the spinal cord, as well as the retina, the optic nerve, the olfactory nerve, and the olfactory epithelium. Visual and/or auditory stimulation may thus be suboptimal for conditions in which the effect of the stimulation needs to extend outside the brain (e.g., to treat peripheral neuropathy or spinal cord injuries), such as to the spinal cord and to portions of the peripheral nervous system (PNS). Generally, in vertebrates including humans, the PNS includes the rest of the nerves, ganglia, etc. that reside outside the brain and the spinal cord. Medication-based treatment options currently available for peripheral neuropathy, which can encompass damage to any nerve outside the CNS, generally do not target the specific areas that have been affected or damaged but instead confer a systemic effect throughout the body.

In view of the foregoing, the Inventors further have recognized and appreciated that there is hence an unmet need for effectively delivering stimulation that induces gamma oscillations to the other parts of the nervous system in addition to the brain, such as peripheral nerves of the PNS and the spinal cord of the CNS, with the ability to target specific areas. Further, the Inventors have recognized and appreciated that, for some indications, substantially greater options are available for the application of tactile stimulus, since it may be possible to apply the tactile stimulus to different body parts and/or locations of the subject, including at the very distal terminations of nerves of the PNS.

Accordingly, one inventive implementation is directed to a method of treating neurodegeneration in a subject that includes administering a non-invasive tactile stimulus having a stimulus frequency of about 30 Hz to about 50 Hz to a subject to induce synchronized gamma oscillations in at least one portion of the peripheral nervous system of the subject.

Another inventive implementation is directed to a method that includes providing a device that administers a non-invasive tactile stimulus to a subject during use of the device, wherein the non-invasive tactile stimulus has a stimulus frequency of approximately 35 Hz to approximately 45 Hz to induce synchronized gamma oscillations in at least one portion of the nervous system of the subject.

Another inventive implementation is directed to a method of treating neurodegeneration in a subject that includes administering a non-invasive tactile stimulus to a subject having a stimulus frequency of about 30 Hz to about 50 Hz to induce synchronized gamma oscillations in at least one portion of the spinal cord of the subject.

Another inventive implementation is directed to a method of treating motor impairment in a subject that includes administering a non-invasive tactile stimulus to a subject having a stimulus frequency of about 30 Hz to about 50 Hz to induce synchronized gamma oscillations at or near a site of motor impairment of the subject.

Another inventive implementation is directed to a method of treating a movement disorder in a subject that includes administering a non-invasive tactile stimulus to a subject having a stimulus frequency of about 30 Hz to about 50 Hz to induce synchronized gamma oscillations at or near a site of the movement disorder of the subject.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTIONS OF THE DRAWINGS

The patent or application file contains at least one drawing executed in color. Copies of this patent or patent application publication with color drawing(s) will be provided by the Office upon request and payment of the necessary fee.

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 is a schematic representation of a tactile GENUS (Gamma ENtrainment Using Sensory stimuli) system, composed of a function generator that produces an electrical signal at 40 Hz (or other frequencies), an audio amplifier that amplifies the signal, and a speaker that converts the amplified signal to a physical movement of a diaphragm. The diaphragm moves up and down at a frequency that matches the frequency of the electrical signal.

FIG. 2A shows photographs of the tactile GENUS experimental system. To deliver the 40 Hz vibration to a mouse model, a mouse cage is placed on top of a speaker. Two rubber bands were clamped between the top of the cage and the top edge of the speaker (one on the left side, one on the right side) to keep the cage from displacing significantly (and potentially falling off) during the vibration

FIG. 2B shows eight different mouses cages, placed on top of respective speakers, that were employed to deliver tactile GENUS in an experimental context.

FIG. 2C illustrates, for the eight cages of FIG. 2B, that tactile GENUS in an experimental context was delivered to the mice in each cage labeled ‘Stim’, and that no tactile GENUS was delivered to the cages labeled ‘No Stim.’

FIG. 3A illustrates a plot of latency to fall over multiple trials for a CKp25 mouse model.

FIG. 3B illustrates a plot of latency to fall over multiple trials for a P301S mouse model.

FIG. 4A illustrates another plot of latency to fall for the CKp25 mouse model.

FIG. 4B illustrates another plot of latency to fall for the P301S mouse model.

FIG. 4C illustrates another plot of latency to fall for a 5xFAD mouse model.

FIG. 5A illustrates a plot of novel object recognition index (NOR) for the CKp25 mouse model.

FIG. 5B illustrates a plot of NOL for the CKp25 mouse model.

FIG. 5C illustrates a plot of NOR for the 5xFAD mouse model.

FIG. 6A illustrates a power spectral density plot of the average EEG response from 32 EEG leads placed on a human subject's scalp, where the human subject has their feet exposed to tactile GENUS at 41 Hz.

FIG. 6B illustrates a topographic map of the EEG response from different brain regions of the subject of FIG. 6A at the peak response frequency (41 Hz).

FIG. 7A illustrates a power spectral density plot of the average EEG response from 32 EEG leads placed on another human subject's scalp, where that human subject has one hand exposed to tactile GENUS at 40 Hz.

FIG. 7B illustrates a topographic map of the EEG response from different brain regions of the subject of FIG. 7A at the peak response frequency (40 Hz).

FIG. 8A shows immunohistochemistry with anti-Ab antibody (D54D2, magenta) in hippocampal CA1 of 11-12-month-old 5xFAD mice after 42 days of 40 Hz tactile GENUS (1 hour/day) or no stimulation.

FIG. 8B illustrates a plot of the plaque number per region of interest (ROI) in the 5xFAD mice of FIG. 8A after 42 days of 40 Hz tactile GENUS (1 hour/day) or no stimulation.

FIG. 8C illustrates a plot of the percentage area covered by Ab-positive plaques in the 5xFAD mice of FIG. 8A after 42 days of 40 Hz tactile GENUS (1 hour/day) or no stimulation.

FIG. 8D illustrates a plot of the mean intensity of the anti-Ab antibody D54D2 in the 5xFAD mice of FIG. 8A after 42 days of 40 Hz tactile GENUS (1 hour/day) or no stimulation.

FIG. 9A shows immunohistochemistry with anti-Ab antibody (D54D2, magenta) in the somatosensory cortex of 11-12-month-old 5xFAD mice after 42 days of 40 Hz tactile GENUS (1 hour/day) or no stimulation.

FIG. 9B illustrates a plot of the plaque number per region of interest (ROI) in the 5xFAD mice of FIG. 9A after 42 days of 40 Hz tactile GENUS (1 hour/day) or no stimulation.

FIG. 9C illustrates a plot of the percentage area covered by Ab-positive plaques in the 5xFAD mice of FIG. 9A after 42 days of 40 Hz tactile GENUS (1 hour/day) or no stimulation.

FIG. 9D illustrates a plot of the mean intensity of the anti-Ab antibody D54D2 in the 5xFAD mice of FIG. 9A after 42 days of 40 Hz tactile GENUS (1 hour/day) or no stimulation.

FIG. 10A shows immunohistochemistry with anti-Iba1 antibody (green) in hippocampal CA1 of 6-month-old CKp25 mice after 42 days of 40 Hz tactile GENUS (1 hour/day) or no stimulation.

FIG. 10B illustrates a plot of the percentage area covered by Iba1-positive microglia per ROI (n=10 mice no stim, 10 mice 40 Hz stim, unpaired t-test, **P<0.01) in the CKp25 mice of FIG. 10A after 42 days of 40 Hz tactile GENUS (1 hour/day) or no stimulation.

FIG. 10C illustrates a plot of the anti-Iba1 antibody mean intensity value normalized to non-stimulated controls (n=10 mice no stim, 10 mice 40 Hz stim, unpaired t-test, ***P<0.001) in the CKp25 mice of FIG. 10A after 42 days of 40 Hz tactile GENUS (1 hour/day) or no stimulation.

### DETAILED DESCRIPTION

All combinations of the foregoing concepts and additional concepts are discussed in greater detail below (provided such concepts are not mutually inconsistent) and are part of the inventive subject matter disclosed herein. In particular, all combinations of claimed subject matter appearing at the end of this disclosure are part of the inventive subject matter disclosed herein. The terminology used herein that also may appear in any disclosure incorporated by reference should be accorded a meaning most consistent with the particular concepts disclosed herein.

As used herein, the terms “treatment” or “treating” refers to both therapeutic treatment and prophylactic or preventive measures. In some embodiments, subjects in need of treatment include those subjects that already have the disease or condition as well as those subjects that may develop the disease or condition and in whom the object is to prevent, delay, or diminish the disease or condition. For example, in some embodiments, the devices, methods, and systems disclosed herein may be employed to prevent, delay, or diminish a disease or condition to which the subject is genetically predisposed. In some embodiments, the devices, methods, and systems disclosed herein may be employed to treat, mitigate, reduce the symptoms of, and/or delay the progression of a disease or condition with which the subject has already been diagnosed.

As used herein, the term “subject” denotes a mammal, such as a rodent, a feline, a canine, or a primate. In some example illustrations, the subject is a human.

The term “about,” as used herein, refers to plus or minus ten percent of the object that “about” modifies.

The term “non-invasive,” as used herein, refers to methods, devices, and systems which do not require surgical intervention or manipulations of the body, such as injection or implantation of a composition or a device. A non-limiting example of non-invasive administration of tactile stimulus is via a transducer placed on the skin or clothing of the subject. The term “invasive,” as used herein, refers to methods, devices, and systems which do require surgical intervention or manipulations of the body. Non-limiting examples of non-invasive administration of stimulus can include audio, visual (e.g., flickering lights), haptic stimulation, combinations of two or more of audio, visual and haptic stimulation, and/or the like. Non-limiting examples of invasive administration of stimulus can include visual, audio, and/or haptic stimulations combined with an injection or implantation into the subject of a composition (e.g., a light-sensitive protein) or a device (e.g., an integrated fiber optic and solid-state light source). Other examples of invasive administration can include magnetic and/or electrical stimulation via an implantable device.

Regarding non-invasive stimuli according to the various inventive concepts disclosed herein, one example of a non-invasive stimulus is a haptic or tactile stimulus (e.g., mechanical stimulation with forces, vibrations, and/or motions), as generally disclosed in PCT Publication Nos. 2017/091698, 2019/074637, and/or 2019/075094, and U.S. Provisional Application No. 63/014,300 the entire disclosure of each of which is incorporated herein by reference. In some cases, the stimulation may include an auditory stimulus and/or a visual stimulus, as generally disclosed in the aforementioned applications. Each of the haptic/tactile stimulus, auditory stimulus, and the visual stimulus can independently be non-invasive, or invasive, or a combination thereof.

In some cases, the subject to whom the tactile stimulus is being administered can be blind or generally visually impaired, such that a visual stimulus as disclosed in the aforementioned applications may be ineffective or sub-optimal for inducing gamma oscillations in the subject. In some cases, the subject can be deaf or generally hearing impaired, such that an auditory stimulus as disclosed in the aforementioned applications may be ineffective or sub-optimal for inducing gamma oscillations in the subject.

The tactile stimulus may include any detectable change in the internal or external environment of the subject that directly or ultimately induces gamma oscillations/results in gamma entrainment. For example, the tactile stimulus may be designed to at least stimulate one or more of mechanoreceptors (e.g., mechanical stress and/or strain), nociceptors (i.e., pain), electroreceptors (e.g., electric fields), magnetoreceptors (e.g., magnetic fields), hydroreceptors, chemoreceptors, thermoreceptors, osmoreceptors, or proprioceptors (i.e., sense of position). The absolute threshold or the minimum amount of sensation needed to elicit a response from such receptors may vary based on the subject. In some cases, the tactile stimulus can be adapted based on individual sensitivity, such as to touch for example.

In one aspect, the present disclosure provides methods, devices, and systems for preventing, mitigating, and/or treating neurodegeneration. Neurodegeneration can generally be characterized as the atrophy and loss of function in neurons. In some cases, the neurodegeneration is caused by one or more of Alzheimer's disease, Parkinson's disease, Huntington's disease, amyotrophic lateral sclerosis (ALS), or multiple sclerosis. In some cases, the neurodegeneration includes a peripheral neuropathy. In some cases, the peripheral neuropathy can be associated with chemobrain in the subject, i.e., is a chemotherapy-induced peripheral neuropathy. In some cases, the peripheral neuropathy is caused in the subject by one or more of an autoimmune disease, diabetes, a viral infection, a bacterial infection, a genetic disorder, a tumor, a bone marrow disorder, a kidney disease, a liver disease, a connective tissue disorder, hypothyroidism, alcoholism, poisoning, medication, chemotherapy, trauma, a vitamin deficiency, hypothermia, muscular dystrophy (e.g., Duchenne muscular dystrophy, Becker muscular dystrophy, congenital muscular dystrophy, myotonic dystrophy, facioscapulohumeral muscular dystrophy, etc.) or an idiopathy.

In another aspect, the present disclosure provides methods, devices, and systems for preventing, mitigating, and/or treating motor impairment in a subject. Generally, motor impairment can be characterized as a partial or total loss of function of a body part such as one or more limbs. The motor impairment can be caused by a traumatic injury (e.g., spinal cord injury, limb damage, and/or limb loss), a disease (e.g., multiple sclerosis, spina bifida, amyotropic lateral sclerosis (ALS), arthritis, Parkinson's disease, and/or an essential tremor), and/or a congenital disorder (e.g., cerebral palsy, muscular dystrophy, or spina bifida).

In another aspect, the present disclosure provides methods, devices, and systems for preventing, mitigating, and/or treating a movement disorder in a subject. A movement disorder can generally be characterized as a neurological condition that causes abnormal movements (e.g., slower than normal, faster than normal, reduced movement, uncontrollable movement, and/or the like), which may be voluntary or involuntary. The movement disorder can be caused by ataxia, cervical dystonia, chorea, dystonia, a functional movement disorder, Huntington's disease, multiple system atrophy, myoclonus, Parkinson's disease, Parkinsonism, progressive supranuclear palsy, restless legs syndrome, tardive dyskinesia, Tourette syndrome, tremor, and/or Wilson's disease.

In another aspect, the present disclosure provides methods, devices, and systems for applying a tactile stimulus to a subject invasively or non-invasively. The tactile stimulus can have a frequency of less than about 20 Hz, about 20 Hz, about 30 Hz, about 40 Hz, about 50 Hz, about 60 Hz, or more than 60 Hz, including all values and sub-ranges in between. As an example, the tactile stimulus can include vibrations, with a tactile frequency of about 35 Hz to about 45 Hz. In some aspects, the tactile frequency can be about 40 Hz. The desired tactile frequency may be achieved, for example, by using a sinusoidal waveform at the desired frequency. As another example, the waveform of the tactile signal can be a “pulsed” waveform in which a pulse of sinusoidal waveform is repeated at an interval that corresponds to the desired tactile frequency. For the pulsed waveform, the duty cycle of the tactile stimulus can be about 4-96%, including all values and sub-ranges in between.

In another aspect, the tactile stimulus can be applied directly (e.g., in contact with a vibrating membrane) or indirectly (e.g., through a cage per Example 1 below, through clothing, via the clothing itself, and/or the like) to the subject. The tactile stimulus can be applied to substantially the entire body of the subject, a general portion thereof (i.e., not targeted, such as the entire back of the subject), or a specific portion there of (i.e., targeted, such as the hand or calf muscle of the subject). In some cases, the tactile stimulus can be applied non-invasively to at least a portion of the peripheral nervous system (PNS) of the subject such as, for example, though skin or body contact with the user in the vicinity of a nerve (e.g., in the vicinity of a receptor of a nerve) of the PNS such as one of the spinal nerves (e.g., ulnar nerve, the tibial nerve, fibular nerve), a cranial nerve other than the optic and olfactory nerves (e.g., the vagus nerve, trigeminal nerve, facial nerve, glossopharyngeal nerve, vestibulocochlear nerve), and/or the like. For example, the tactile stimulus can be applied to the skin of the user over the region or area where it is known or estimated that the target nerve innervates and/or passes under. Without being limited by theory, application of tactile stimulus may have the desired effect on the target nerve either by nerve receptors sensing the tactile stimulus, or by physical movement of the nerve itself caused by the tactile stimulus, or both. As an illustrative example, consider the ulnar nerve that passes through the arm of a subject and reaches the fingers of the subject. The ulnar nerve can then be targeted for stimulation by applying the tactile stimulus to one or more fingers of the hand of the subject, the palm area of the hand of the subject, the wrist of the subject, the arm of the subject, and/or the like.

The portion can include the somatic nervous system (e.g., afferent (sensory) and efferent (motor) nerves) and/or the autonomous nervous system (e.g., the sympathetic nervous system and/or the parasympathetic nervous system) of the subject. In some cases, the portion can include a neuromuscular junction. In some cases, the tactile stimulus can be applied non-invasively to at least a portion of the spinal cord of the subject such as, for example, though skin or body contact with the user in the vicinity of a spinal nerve, the brachial plexus, and/or the like.

In another aspect, the tactile stimulus can be applied for a duration of about 15 minutes, about 30 minutes, about an hour, about two hours, about four hours more than four hours, including all values and sub-ranges in between. In another aspect, the tactile stimulus can be applied for a predetermined duration (e.g., about an hour) once or daily for a week, for two weeks, three weeks, a month, or more than a month, including all values and sub-ranges in between. In some cases, the tactile stimulus can be applied for about an hour a day for at least three weeks. In some cases, the tactile stimulus can be applied for about an hour a day for at least six weeks.

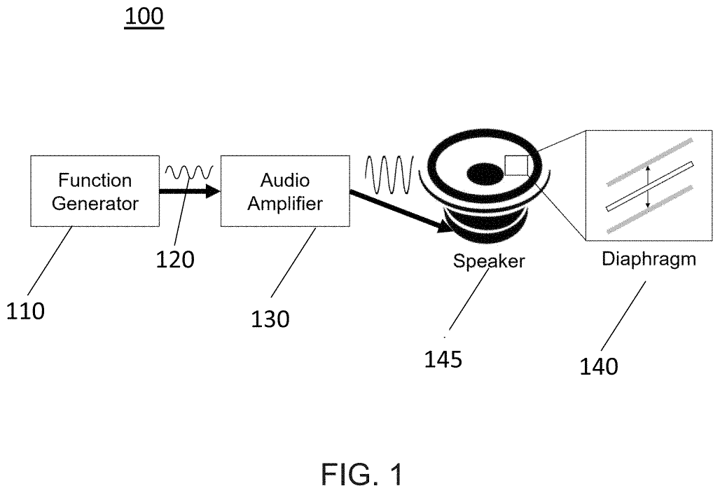

In another aspect, the devices and/or systems for applying the tactile stimulus can be structurally and/or functionally similar to the example system 100 illustrated in FIG. 1. A signal generator 110 can generate a control signal 120 to be applied to a vibration device 140 (here, a diaphragm 140 of a speaker 145) that vibrates at the tactile frequency to generate the tactile stimulus. FIG. 1 also illustrates an optional amplifier 130 that can be used to amplify the control signal 120 if needed or desired. While not illustrated in FIG. 1, the system 100 can further include a processor to control operation of the components of the system 100, such as the signal generator 110, the amplifier 130, and/or the like. The system 100 can also include a memory (not shown) storing processor-executable instructions such as, for example, to control the signal generator 110. The memory can also store treatment/protocol related information such as, for example, duration of application of the tactile stimulus through the vibration device 140. In some cases, the system 100 can be configured for whole body vibration, e.g., a whole body vibration machine, a massage chair, and/or the like. In some cases, the vibration device 140 can be configured to generate the tactile stimulus as a pivotal/oscillatory motion, linear (e.g., vertical) motion, tri-plane motion, elliptical motion, sonication, and/or combinations thereof. In some cases, the vibration device 140 can be electric motor-based. In some cases, the vibration device 140 can be an electro-mechanical vibrator. In some cases, the vibration device 140 can be piezoelectric motor-based. In some cases, the system 100 can take a form appropriate for the stimulation of a specific body part. For example, the system 100 can include or encompass a band (e.g., a Smartwatch that vibrates), or a handheld device with a vibrating platform that is sized to be directly placed against the body part to which the tactile stimulus is to be applied.

In some cases, the device/apparatus for administering the tactile stimulus can encompass a wearable component. The wearable component can have one or more vibrating elements coupled to it (sometimes collectively referred to as a wearable device) in any suitable manner such as via stitching, glue, interwoven (e.g., piezoelectric textile fibers), one or more pins, and/or the like. Components such as a power source, controller, etc. for powering and/or controlling operation of the vibrating elements may each be independently disposed on the wearable component, or coupled thereto in a wired or wireless (e.g., a controller receiving wireless instructions via a network interface, a power source that can be inductively charged, and/or the like) manner. Non-limiting examples of such wearable devices can include:

Any type of headwear, such as a cap or hat (e.g., ball cap, baseball cap skull cap, fedora, beret, beanie, and/or the like) or headband including one or more electric motor(s), acoustic and/or piezoelectric transducers to deliver tactile stimulus to the scalp/head region of the subject;

Any type of handwear and/or armwear, such as gloves (e.g., slipons, fingerless gloves, mittens, opera gloves, gauntlet gloves, arm length gloves, arm warmers, and/or the like), bands (e.g., wristbands), rings, including one or more electric motor(s), acoustic and/or piezoelectric transducers (e.g., position to interface with one or more finger tips, one or more fingers, the palm of the subject's hand, the back of the subject's hand, the wrist of the subject, the forearm of the subject, the elbow of the subject, the bicep of the subject, combinations thereof, portions thereof, and/or the like) to deliver tactile stimulus to the hand and/or arm of the subject;

Any type of upper body clothing, such as shirts (e.g., sleeveless, tank tops, t-shirts, V-neck shirts, polo shirts, jerseys, long sleeve jerseys, sweatshirts, turtlenecks, hoodies, dress shirts, tuxedo shirts, sweaters, cardigans, jackets, vests, and/or the like), necklaces, chest straps, etc., including one or more electric motor(s), acoustic and/or piezoelectric transducers (e.g., position to interface with the upper chest, upper back, mid chest, mid back, abdominal region, lower back, combinations thereof, portions thereof, and/or the like) to deliver tactile stimulus to the upper body of the subject;

Any type of footwear and/or legwear, such as socks (e.g., toe covers, no-show socks, low cut socks, anklets, crew socks, over-the-calf socks, knee high socks, calf warmers, over the knee socks, and/or the like), shoes (e.g., flip flops, shoes with heels, sandals, sports shoes such as trainers, casual shoes such as loafers and docksides, formal shoes such as Oxfords and Derbies, boots such as thigh high boots and rain boots, and/or the like), etc. including one or more electric motor(s), acoustic and/or piezoelectric transducers (e.g., position to interface with one or more toes of the subject's foot, upper side of the subject's foot, the palm of the subject's foot, the Achilles of the subject, the lower leg, the knee joint, the upper leg, the groin, combinations thereof, portions thereof, and/or the like) to deliver tactile stimulus to the legs and/or feet of the subject;

Any type of lower body clothing, such as underwear, shorts and/or pants (e.g., briefs, boxer briefs, boxers, Bermuda shorts, short pants, cargo pants, short tights, jeans, trousers, running tights, joggers, and/or the like), ankle bands, etc., including one or more electric motor(s), acoustic and/or piezoelectric transducers (e.g., position to interface with the lower leg, the knee joint, the upper leg, the groin, the glutes, combinations thereof, portions thereof, and/or the like) to deliver tactile stimulus to the lower body of the subject; and/or

Any other type of body wear, such as a body suit (e.g., a compression suit, similar to a dry suit) including one or more electric motor(s), acoustic and/or piezoelectric transducers (e.g., position to interface with the lower leg, the knee joint, the upper leg, the groin, the glutes, combinations thereof, portions thereof, and/or the like) to deliver tactile stimulus to the covered body portions of the subject.

As a nonlimiting example, a subject suffering from heat allodynia due to chemotherapy treatment can wear a glove that includes, stitched into its inner surface, a piezoelectric transducer disposed on each fingertip. The five transducers can then be coupled to a microcontroller and an inductively rechargeable power source. The microcontroller can receive instructions from a remote device (e.g., a smartphone application executing on a device associated with the subject or with a healthcare provider of the subject) and control the delivery of power to the transducers, which in turn can generate and deliver vibrations to the fingers of the user at 40 Hz.

In some cases, applying the tactile stimulus can generally result in improvement or stabilization in motor function of the subject. In some cases, the improvement in motor function includes improvement in motor coordination. In some cases, the improvement in motor function includes improvement in grip strength. In some cases, the improvement in motor function includes improvement in motor coordination (e.g., in reflexes, synergies, motor programs, and/or synergies).

Without being limited by theory, recovery from neurodegeneration and/or motor impairment can be improved by the precise timing of oscillations in neural, glial, and/or muscle activity in the affected region(s), specifically in the gamma frequency range (e.g., about 20 Hz to about 100 Hz, about 20 Hz to about 80 Hz, or about 20 Hz to about 60 Hz). Additionally or alternatively, increased activity related to somatosensory neurons might strengthen neural circuits in the affected/target region(s), resulting in better tactile sensation that can help motor coordination. Additionally or alternatively, tactile stimulation at gamma frequencies may resolve neuroinflammation in areas of the peripheral nervous system and/or the brain area(s) involved in movement, therefore restoring motor function. Additionally or alternatively, tactile stimulation GENUS may recruit immune cells to help ameliorate pathology in the target regions of the peripheral nervous system. Additionally or alternatively, myelination of the neuronal axons in the efferent nerves may be strengthened/restored in the target region(s), which can improve signal transduction from the motor cortex from the brain to the neuromuscular junctions (NMJs). Additionally or alternatively, damaged NMJs in the target region(s) may be restored such as when, for example, NMJs may be damaged due to chemotherapy and/or due to amyotrophic lateral sclerosis (ALS), Myasthenia Gravis (MG), Lambert-Eaton syndrome (LES), botulism, and/or the like.

Without being limited by theory the impact of tactile stimulation on neurodegeneration such as (but not limited to) improvement in hippocampal memory, reduction in levels of amyloid-beta plaques, reduction in tau phosphorylation, and/or the like, may occur for similar reasons as for audio-visual stimulation at gamma frequencies such as (but not limited to) modulation of microglia morphology and/or behavior, changes in numbers of reactive astrocytes, changes in vasculature, and/or the like.

### Example 1

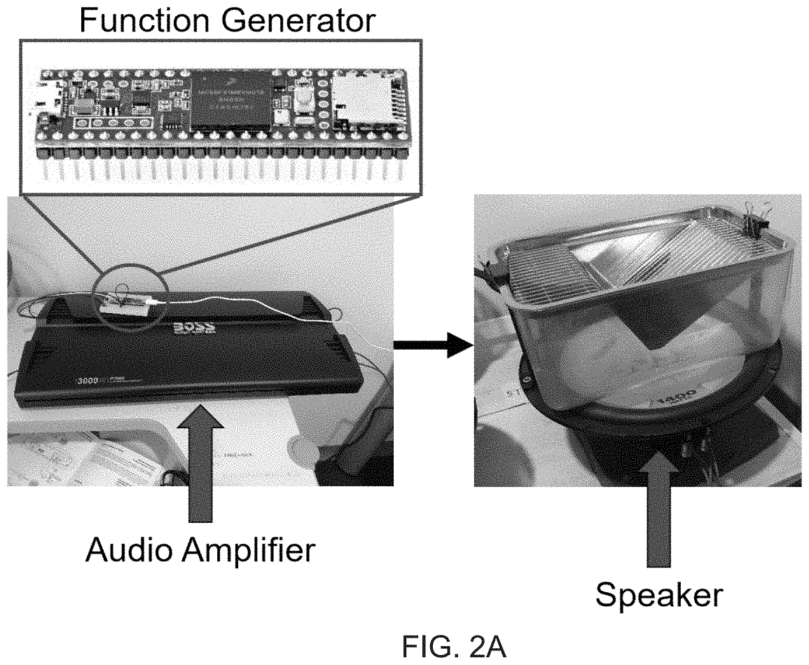

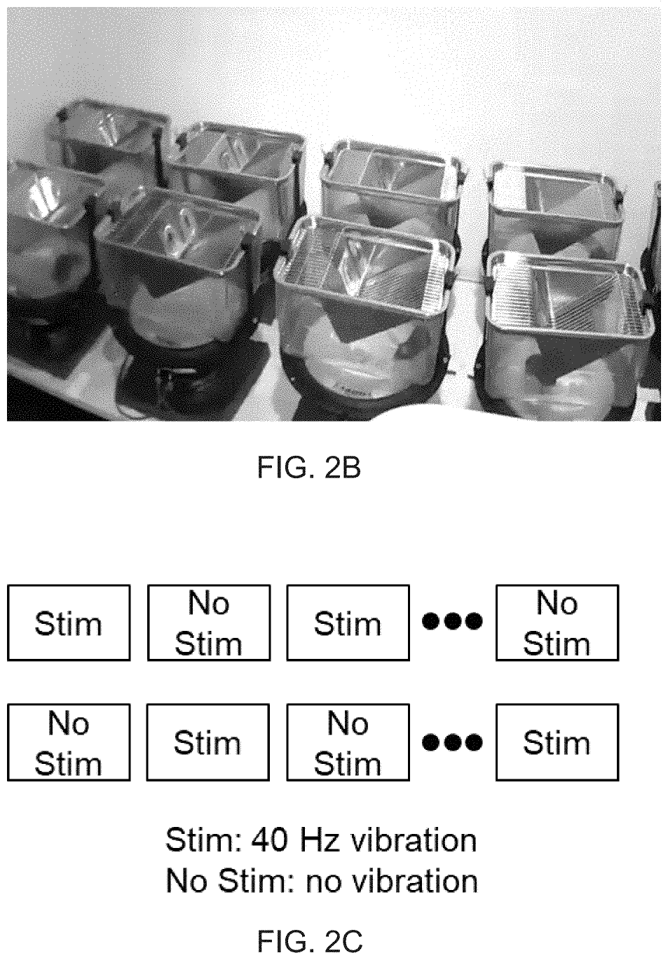

This example describes gamma-frequency sensory stimulation that can improve motor function and cognition in conditions that entail motor function and cognitive deficits (e.g., neurodegeneration). FIG. 1 illustrates a non-invasive system composed of a function generator, audio amplifier, and a speaker, which can be used to generate gamma frequency (e.g., 40 Hz) vibrations. A microcontroller (e.g., a version of an Arduino board called Teensyduino) is used as a function generator, and the system also includes a high-power audio amplifier (e.g., 3000 W audio amplifier from BOSS), and a subwoofer (e.g., 1400 W subwoofer from BOSS) (FIG. 2).

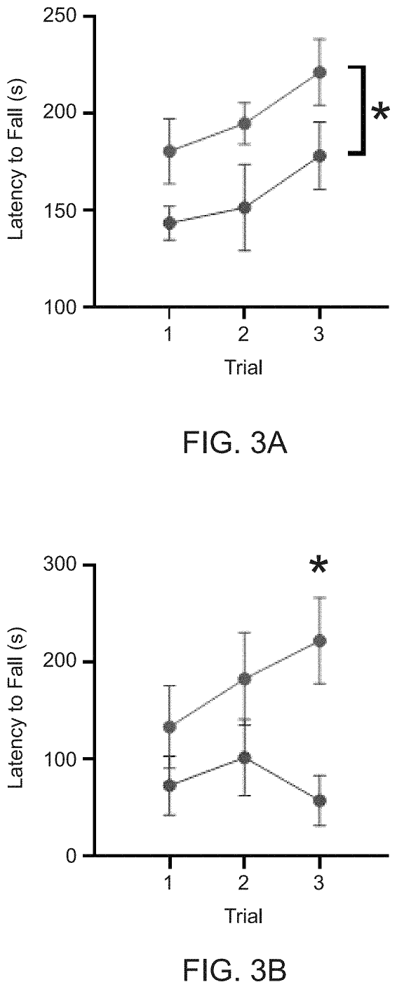

When mouse models of neurodegeneration (e.g., CKp25 mice and P301S mice) or Alzheimer's disease (e.g., 5xFAD mice) were exposed to the 40 Hz vibration (by placing a cage on top of the speaker; FIGS. 2A-2C) 1 hour per day for 3-6 weeks, it was found that the mice exposed to the vibration showed improved motor function as well as cognition compared to mice that were not stimulated (FIGS. 3-5).

Referring to the aforementioned mouse models, generally, CKp25 mice show severe neurodegeneration under p25 induction. P301S mice also show neuronal loss, gliosis, and neurofibrillary tangle-like inclusions inside neurons. 5xFAD mice develop amyloid plaques, in addition to gliosis and neuronal loss. Accordingly, all three mice models exhibit some, but not all, of the pathology associated with Alzheimer's disease.

Referring again to FIGS. 3A-3B, these figures illustrate how chronic exposure to tactile GENUS improves performance on rotarod, suggesting improved motor coordination, and in turn suggesting an effect of tactile GENUS on at least the spinal cord and/or the PNS. FIG. 3A illustrates that, 6-month old female CKp25 mice that were stimulated 1 hour/day for 38 days (red) took significantly longer to fall from a rotating rod compared to mice that were not stimulated (blue) across 3 trials. n=6 mice no stim, n=5 mice 40 Hz stim, 2-way ANOVA with Sidak's multiple comparison, *P<0.05. FIG. 3B illustrates that, 9-month old male P301S mice that were stimulated 1 hour/day for 17 days (red) took significantly longer to fall from a rotating rod compared to mice that were not stimulated (blue) at the third trial. n=4 mice no stim, n=5 mice 40 Hz stim, 2-way ANOVA with Sidak's multiple comparison, *P<0.05. The difference in time to fall between the stimulated mice (red) and non-stimulated mice (blue) became significant only at trial 3, likely due to the stimulated mice showed an increasing trend for time to fall across 3 trials when non-stimulated mice showed no such trend across 3 trials, suggesting improved motor memory with tactile GENUS.

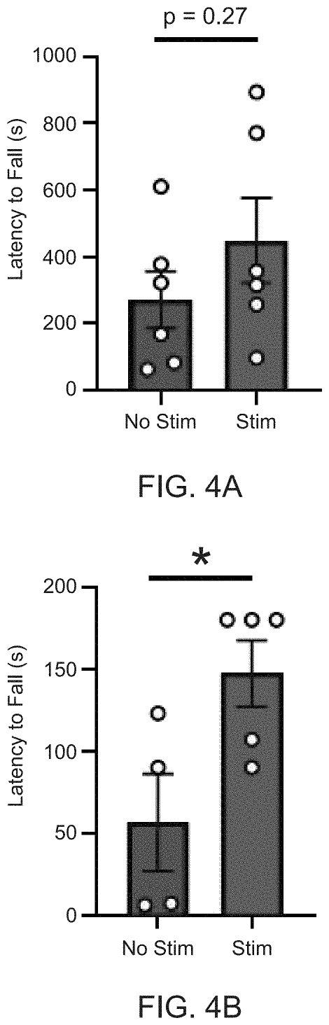

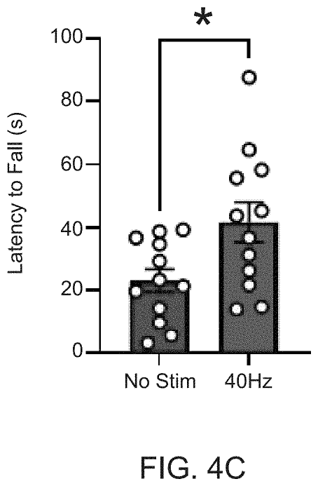

FIGS. 4A-4C illustrate how chronic exposure to tactile GENUS improves performance on grid hang, suggesting improved grip strength, also suggesting an effect of tactile GENUS on at least the spinal cord and/or the PNS. FIG. 4A illustrates that, 6-month old female CKp25 mice that were stimulated 1 hour/day for 39 days (red) took longer to fall from an inverted grid compared to mice that were not stimulated (blue). n=6 mice no stim, n=6 mice 40 Hz stim, unpaired t-test, P=0.27. FIG. 4B illustrates that, 9-month old male P301S mice that were stimulated 1 hour/day for 21 days (red) took significantly longer to fall from an inverted grid compared to mice that were not stimulated (blue). n=4 mice no stim, n=5 mice 40 Hz stim, unpaired t-test, *P<0.05. FIG. 4C illustrates that 11-12-month-old male 5xFAD mice that were stimulated 1 hour/day for 37 or 38 days (red) took significantly longer to fall from an inverted grid compared to mice that were not stimulated (blue). n=12 mice no stim, n=12 mice 40 Hz stim, unpaired t-test, *P<0.05.

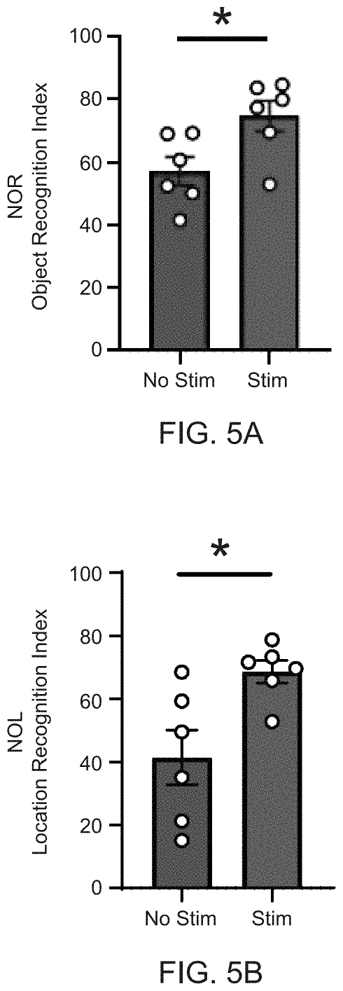

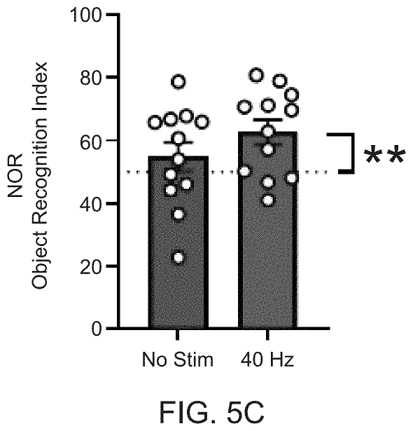

FIGS. 5A-5C illustrate how chronic exposure to tactile GENUS improves performance on novel object recognition and location, suggesting improved memory for object and location. FIG. 5A illustrates that, 6-month old female CKp25 mice that were stimulated 1 hour/day for 33 days (red) showed a significantly higher object recognition index compared to mice that were not stimulated (blue). n=6 mice no stim, n=6 mice 40 Hz stim, unpaired t-test, *P<0.05. FIG. 5B illustrates that, 6-month old CKp25 mice that were stimulated 1 hour/day for 33 days (red) showed a significantly higher location recognition index compared to mice that were not stimulated (blue). n=6 mice no stim, n=6 mice 40 Hz stim, unpaired t-test, *P<0.05. FIG. 5C illustrates that 11-12-month-old male 5xFAD mice that were stimulated 1 hour/day for 34 or 35 days (red) showed a significantly higher preference for the novel object compared to the familiar object (represented by the object recognition index that is significantly higher than 50). 5xFAD mice that were not stimulated (blue) did not show such preference. n=12 mice no stim, one sample t-test with hypothetical value 50, P=0.323; n=12 mice 40 Hz stim, one sample t-test with hypothetical value 50, **P<0.01.

Existing methods for non-invasive brain stimulation include direct application of external signals to the human brain, such as transcranial magnetic stimulation, transcranial electrical stimulation, and/or the like. Although these methods have been shown to be effective at stimulating the human brain, the devices and equipment needed to deliver these stimuli are quite complex and thus difficult to manufacture and operate. On the other hand, the example setup of FIG. 1, employing a tactile stimulus, can utilize off-the-shelf components and materials, making it more accessible. In addition, 40 Hz vibration (i.e., tactile GENUS) uses a different sensory modality/approach than the light and sound-based 40 Hz stimulation previously developed, which makes it more suitable for when light and sound stimulation may not be appropriate and/or effective (e.g., in people with severe visual or auditory impairment). Tactile GENUS can also have a more local and direct impact on neuromuscular junctions (NMJs) and the peripheral nervous system (PNS) compared to visual and auditory GENUS, which could be potentially beneficial for conditions that involve damages to NMJs and the PNS (e.g., peripheral neuropathy caused by chemotherapy, multiple sclerosis, ALS).

Aspects of the systems and methods described here can be easily integrated into a daily life (e.g., by making a massage mattress that one can sit or lie down on, or a portable wristband or vest that one can wear and take anywhere), making long-term, repetitive delivery of the tactile GENUS stimulation possible.

### Example 2

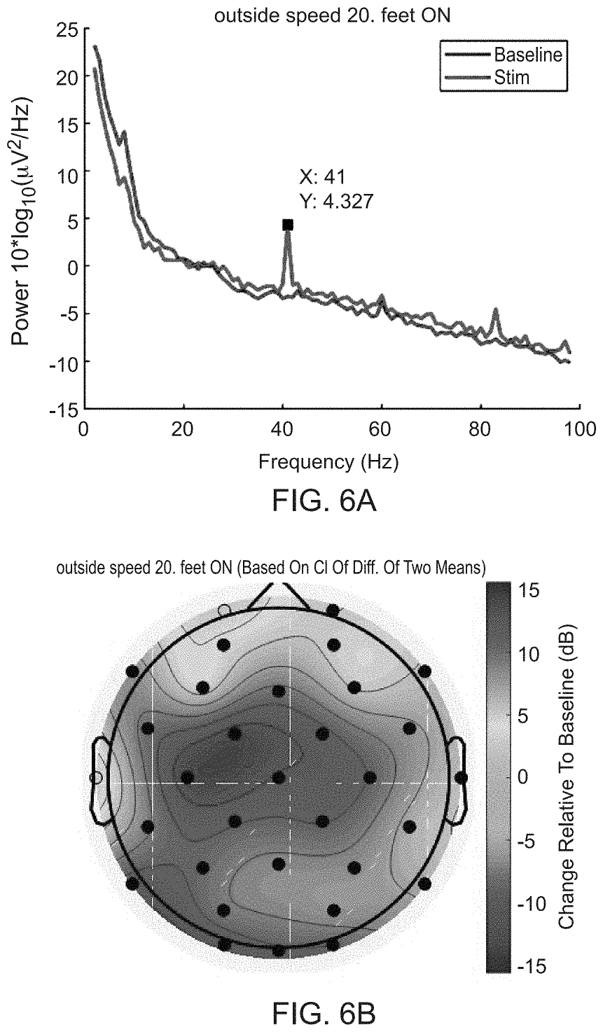

FIGS. 6A-6B illustrate EEG data from a healthy human subject to whom tactile GENUS was applied. The subject placed their two feet on a vibration platform (Vibration Therapeutic®'s Vibration Plate Model VT003F) which was vibrating horizontally for about one minute at a measured rate of about 41 Hz, a slight departure from the manufacturer-indicated 40 Hz. The topographic map of FIG. 6B illustrates that a strong response is observed in the parietal region that includes the somatosensory cortex, which is the main sensory receptive area for the sense of touch and vibration. Some bleed-through of the response to the central and frontal regions of the subject's brain is also observed.

### Example 3

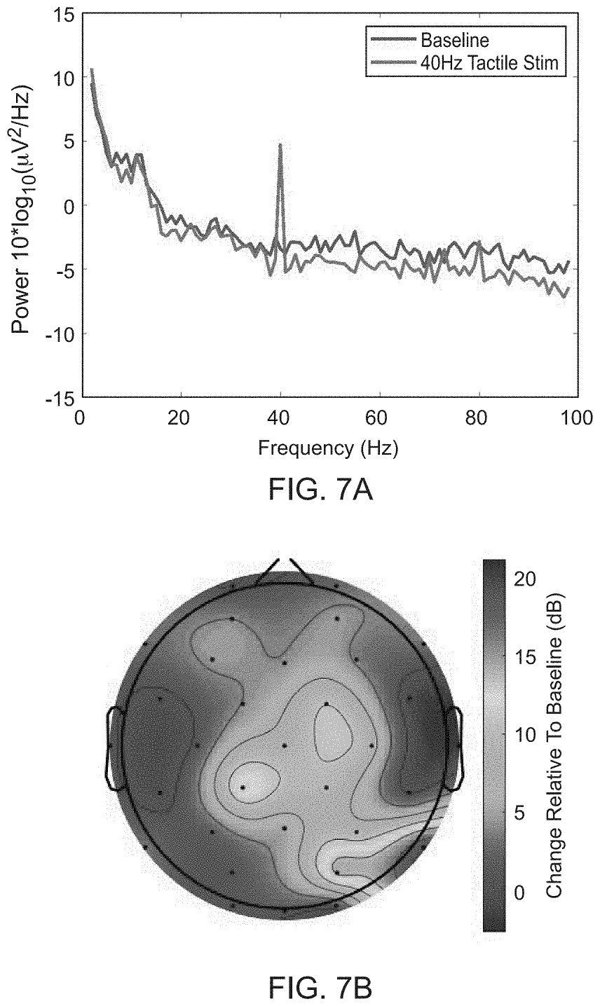

FIGS. 7A-7B illustrate EEG data from another healthy human subject to whom tactile GENUS was applied. The subject placed the index finger, middle finger, and ring finger of their left hand for about one minute on a speaker whose diaphragm (e.g., similar to the diaphragm 140) was vibrating at 40 Hz. The topographic map of FIG. 7B illustrates that a strong response is again observed in the parietal region, and in a portion that is contralateral to the stimulated (left) side of the subject.

### Example 4

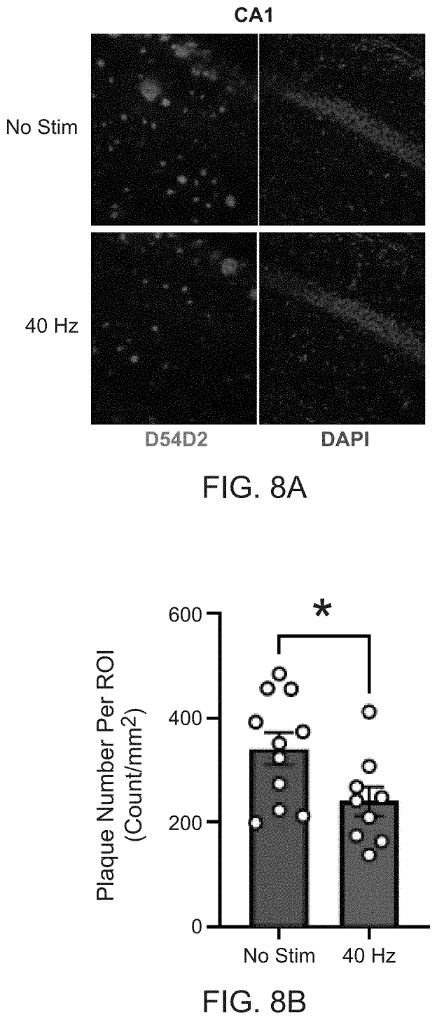

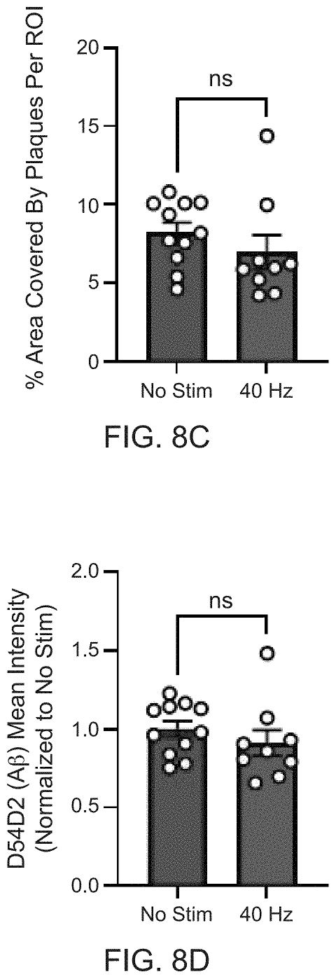

FIGS. 8A-8D illustrate how chronic exposure to tactile GENUS reduced the plaque load in hippocampal CA1 of 5xFAD mice. FIG. 8A illustrates an example immunohistochemistry image with anti-Ab antibody (D54D2, magenta) and cell nucleus (DAPI, blue) staining in hippocampal CA1 of 11-12-month-old male 5xFAD mice after 42 days of 40 Hz tactile GENUS (1 hour/day) or no stimulation. FIG. 8B illustrates that CA1 of 11-12-month old male 5xFAD mice that were stimulated 1 hour/day for 42 days (red) had a significantly lower average number of Ab-positive plaques compared to mice that were not stimulated (blue). n=11 mice no stim, 9 mice 40 Hz stim, unpaired t-test, *P<0.05. FIG. 8C illustrates that CA1 of 11-12-month old male 5xFAD mice that were stimulated 1 hour/day for 42 days (red) had a lower average percentage of area covered by Ab-positive plaques compared to mice that were not stimulated (blue). n=11 mice no stim, 9 mice 40 Hz stim, unpaired t-test, P=0.303. FIG. 8D illustrates that CA1 of 11-12 month old male 5xFAD mice that were stimulated 1 hour/day for 42 days (red) had a lower anti-Ab antibody (D54D2) mean intensity value compared to mice that were not stimulated. n=11 mice no stim, 9 mice 40 Hz stim, unpaired t-test, P=0.349.

### Example 5

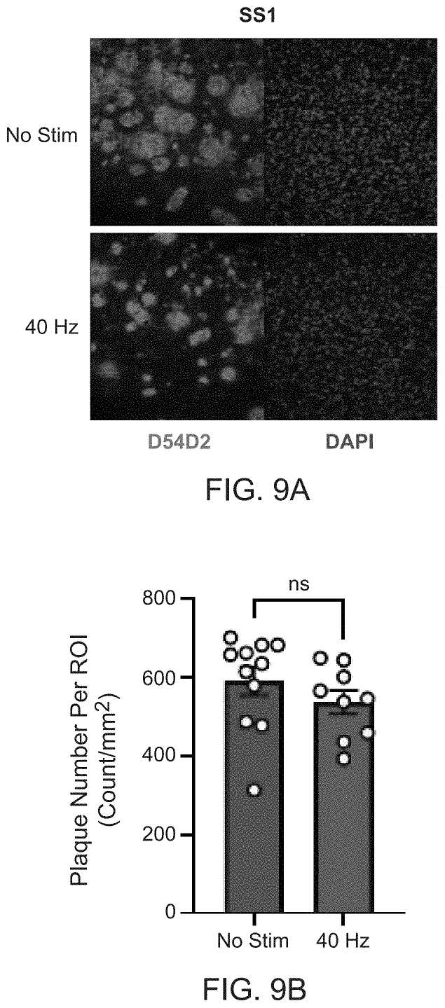

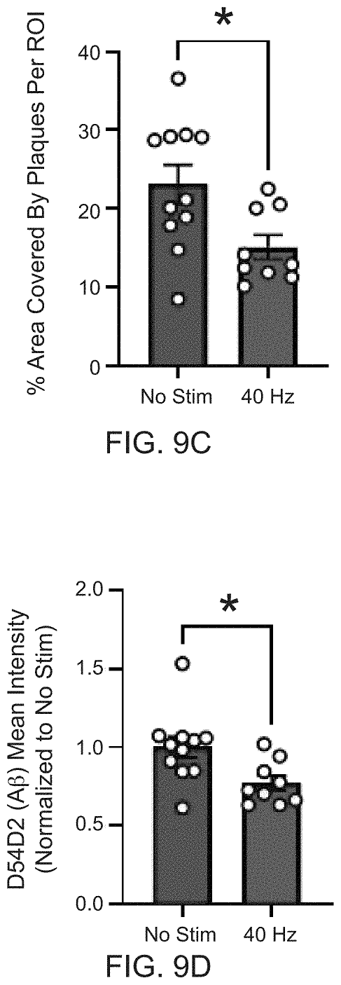

FIGS. 9A-9D illustrate how chronic exposure to tactile GENUS reduced the plaque load in the primary somatosensory cortex (SS1) of 5xFAD mice. FIG. 9A shows an example immunohistochemistry image with anti-Ab antibody (D54D2, magenta) and cell nucleus (DAPI, blue) staining in SS1 of 11-12-month-old male 5xFAD mice after 42 days of 40 Hz tactile GENUS (1 hour/day) or no stimulation. FIG. 9B illustrates that SS1 of 11-12-month old male 5xFAD mice that were stimulated 1 hour/day for 42 days (red) had a lower average number of Ab-positive plaques compared to mice that were not stimulated (blue). n=11 mice no stim, 9 mice 40 Hz stim, unpaired t-test, P=0.284. FIG. 9C illustrates that SS1 of 11-12-month old male 5xFAD mice that were stimulated 1 hour/day for 42 days (red) had a significantly lower average percentage of area covered by Ab-positive plaques compared to mice that were not stimulated (blue). n=11 mice no stim, 9 mice 40 Hz stim, unpaired t-test, *P<0.05. FIG. 9D illustrates that SS1 of 11-12-month old male 5xFAD mice that were stimulated 1 hour/day for 42 days (red) had a significantly lower anti-Ab antibody (D54D2) mean intensity value compared to mice that were not stimulated (blue). n=11 mice no stim, 9 mice 40 Hz stim, unpaired t-test, *P<0.05.

### Example 6

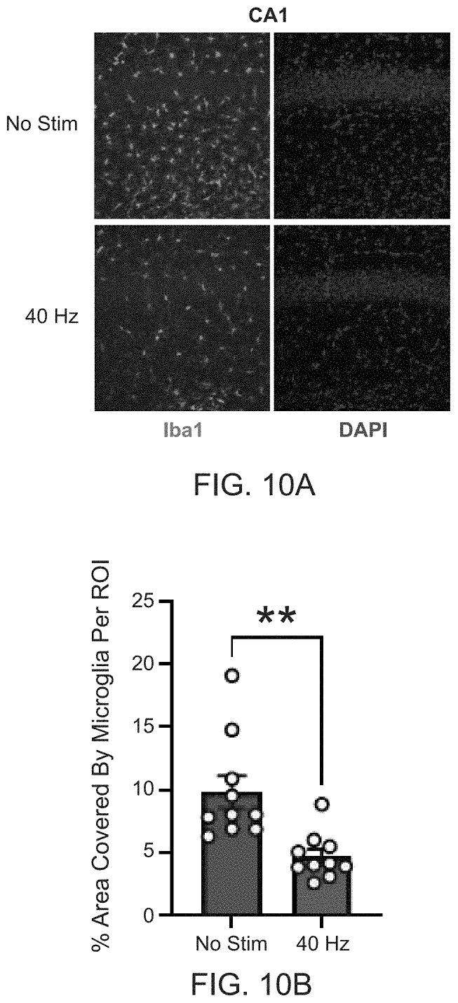

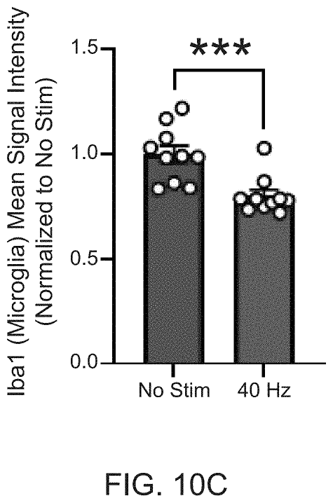

FIGS. 10A-10C illustrate how chronic exposure to tactile GENUS can reduces microgliosis in hippocampal CA1 of CKp25 mice. FIG. 10A shows an example immunohistochemistry image with anti-Iba1 antibody (green) and cell nucleus (DAPI, blue) staining in hippocampal CA1 of 6-month-old female CKp25 mice after 42 days of 40 Hz tactile GENUS (1 hour/day) or no stimulation. FIG. 10B shows that CA1 of 6-month old female CKp25 mice that were stimulated 1 hour/day for 42 days (red) had a significantly lower average percentage of area covered by Iba1-positive microglia compared to mice that were not stimulated (blue). n=10 mice no stim, 10 mice 40 Hz stim, unpaired t-test, **P<0.01. FIG. 10C shows that CA1 of 6-month old female CKp25 mice that were stimulated 1 hour/day for 42 days (red) had a significantly lower anti-Iba1 antibody mean intensity value compared to mice that were not stimulated (blue). n=10 mice no stim, 10 mice 40 Hz stim, unpaired t-test, **P<0.01.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method of treating neurodegeneration in a subject, the method comprising:
administering a non-invasive tactile stimulus having a stimulus frequency of about 30 Hz to about 50 Hz to a subject to induce synchronized gamma oscillations in at least one portion of the peripheral nervous system of the subject.

2. The method of claim 1, wherein the at least one portion includes the somatic nervous system of the subject.

3. (canceled)

4. (canceled)

5. The method of claim 1, wherein the at least one portion includes the autonomous nervous system of the subject.

6. (canceled)

7. (canceled)

8. The method of claim 1, wherein the at least one portion includes a neuromuscular junction of the subject.

9. The method of claim 1, wherein the stimulus frequency is about 40 Hz.

10. The method of claim 1, wherein the tactile stimulus is non-invasively administered for at least about one hour.

11. The method of claim 1, wherein the tactile stimulus is non-invasively administered for at least about one hour a day for at least three weeks.

12. The method of claim 1, wherein the neurodegeneration includes a peripheral neuropathy caused in the subject by one or more of an autoimmune disease, diabetes, a viral infection, a bacterial infection, a genetic disorder, a tumor, a bone marrow disorder, a kidney disease, a liver disease, a connective tissue disorder, hypothyroidism, alcoholism, poisoning, medication, chemotherapy, trauma, a vitamin deficiency, or an idiopathy.

13. (canceled)

14. The method of claim 1, wherein the neurodegeneration is caused by one or more of Alzheimer's disease, Parkinson's disease, Huntington's disease, amyotrophic lateral sclerosis (ALS), or multiple sclerosis.

15. (canceled)

16. (canceled)

17. The method of claim 1, wherein administering the non-invasive tactile stimulus comprises administering the non-invasive tactile stimulus to improve motor coordination of the subject.

18. The method of claim 1, wherein administering the non-invasive tactile stimulus comprises administering the non-invasive tactile stimulus to improve a grip strength of the subject.

19. The method of claim 1, the administering including administering the tactile stimulus to a hand of the subject, to a foot of the subject, or both.

20. (canceled)

21. (canceled)

22. A method of treating neurodegeneration in a subject, the method comprising:
administering a non-invasive tactile stimulus to a subject having a stimulus frequency of about 30 Hz to about 50 Hz to induce synchronized gamma oscillations in at least one portion of the spinal cord of the subject.

23. A method of treating motor impairment in a subject, the method comprising:
administering a non-invasive tactile stimulus to a subject having a stimulus frequency of about 30 Hz to about 50 Hz to induce synchronized gamma oscillations at or near a site of motor impairment of the subject.

24. The method of claim 23, wherein the motor impairment is caused in the subject by one or more of a traumatic injury, a disease, or a congenital condition.

25. The method of claim 24, wherein the traumatic injury includes one or more of spinal cord injury, limb damage, or limb loss.

26. The method of claim 25, wherein the disease includes one or more of multiple sclerosis, spina bifida, amyotropic lateral sclerosis (ALS), arthritis, Parkinson's disease, or essential tremor.

27. The method of claim 25, wherein the congenital condition includes one or more of cerebral palsy, muscular dystrophy, or spina bifida.

28. The method of claim 25, wherein administering the non-invasive tactile stimulus comprises administering the non-invasive tactile stimulus to improve motor coordination of the subject, to improve a grip strength of the subject, or both.

29. (canceled)

30. The method of claim 25, wherein the stimulus frequency is about 40 Hz.

31. (canceled)

32. (canceled)

33. (canceled)
